(19) United States
(12) Patent Application Publication
(10) Pub. No.: US 2015/0035203 A1
(43) Pub. Date: Feb. 5, 2015

(54) COMPOSITION AND METHOD FOR PRODUCING A MATTE FINISH ON THERMOFORMED ACRYLIC SHEETS

(71) Applicants: Scott LaFollette, Florence, KY (US); Mark Gatman, Florence, KY (US); Jim Cannoy, Forence, KY (US)

(72) Inventors: Scott LaFollette, Florence, KY (US); Mark Gatman, Florence, KY (US); Jim Cannoy, Forence, KY (US)

(73) Assignee: Aristech Surfaces LLC, Florence, KY (US)

(21) Appl. No.: 14/450,749

(22) Filed: Aug. 4, 2014

Related U.S. Application Data
(60) Provisional application No. 61/861,969, filed on Aug. 3, 2013.

(51) Int. Cl. B29C 51/02; B29C 39/00; C08L 33/14

(52) U.S. Cl. CPC B29C 51/02; C08L 33/14; B29C 39/003; C08L 2203/30; C08L 2205/02; C08L 2205/06; B29K 2033/12
USPC 264/284; 525/223; 524/523; 524/423

(57) ABSTRACT

A composition for making a cast, thermoformable sheet or slab having a matte surface comprising a syrup comprising about 90% SSI—acrylic pre-polymerized syrup at 20% solids; and about 4-10% particles of about 10-15 microns in diameter of a copolymer of methyl methacrylate and ethylene glycol dimethacrylate or such particles of barium sulfate, calcium carbonate and/or silica. A method for producing a they article having a matte surface comprising mixing a syrup comprising about 90% SSI—acrylic pre-polymerized syrup at 20% solids; and about 4-10% particles of about 10-15 microns in diameter of a copolymer of methyl methacrylate and ethylene glycol dimethacrylate or such particles of barium sulfate, calcium carbonate and/or silica; heating the syrup; casting the syrup into a sheet; and thermoforming the cast sheet against a mold.

### BACKGROUND

### Field of the Disclosure

Typical methods of obtaining a matted surface are usually achieved during the casting or extrusion process by imparting a roughened surface to the liquid or molten acrylic. This results in a sheet that has a matted surface once the casting or extrusion process is complete. The downside is that upon subsequent thermoforming the matted appearance often is decreased or disappears when the hot, rubbery acrylic is stretched into the desired configuration.

According to preferred compositions and/or methods of the present disclosure, rigid particles with a mean diameter of 5-20 um are added to cast acrylic in the liquid state, prior to polymerization into a solid sheet. These particles are added at a loading of 4-10% of the total weight of the sheet and can consist of either cross-linked polymer or inorganic materials. Upon completion of the casting process, these sheets show no discernible difference from a standard sheet without particulate added. In a subsequent thermo-forming (heating and stretching) process the particulate filled sheets show a distinct texture that result in a surface having significantly reduced gloss over the standard acrylic sheet.

These and other advantages of the disclosure will be appreciated by reference to the detailed description of the preferred embodiment(s) that follow.

### SUMMARY OF THE DISCLOSURE

In a preferred aspect, the present disclosure comprises a composition for making a cast, thermoformable sheet or slab, comprising: a syrup comprising: about 90% SSI—acrylic pre-polymerized syrup at 20% solids; and about 4-10% particles of a copolymer of methyl methacrylate and ethylene glycol dimethacrylate. Preferably, the particles are about 10-15 microns in diameter.

In another preferred aspect, the particles are about 12 microns in diameter.

In yet another preferred aspect, the particles are about 15 microns in diameter.

In another preferred aspect, the particles have a generally spherical shape.

In yet another preferred aspect, the syrup comprises about 6% particles of a copolymer of methyl methacrylate and ethylene glycol dimethacrylate.

In another preferred aspect, the syrup further comprises one or more of an anti-flocculating agent; a pigment; a chain transfer agent; a release agent; a crosslinking agent and an initiator.

In yet another preferred aspect, the syrup further comprises: about 3.0% of a pigment; about 0.6% of an anti flocculating agent; about 0.1% of a chain transfer agent; about 0.01% of a release agent; about 0.2% of a crosslinking agent; and about 0.1-0.2% of one or more initiators.

In another preferred aspect, the present disclosure comprises a composition for making a cast, thermoformable sheet or slab, comprising: a syrup comprising: about 90% SSI—acrylic pre-polymerized syrup at 20% solids; and about 4-10% particles made up of barium sulfate, calcium carbonate and/or silica. Preferably the particles are about 10-15 microns in diameter.

In yet another preferred aspect, the present disclosure comprises a method for producing a thermoformed article having a matte surface comprising: mixing a syrup comprising: about 90% SSI—Acrylic pre-polymerized syrup at 20% solids; and about 4-10% particles of a copolymer of methyl methacrylate and ethylene glycol dimethacrylate; heating the syrup; casting the syrup into a sheet; and thermoforming the cast sheet against a mold. Preferably the particles are about 10-15 microns in diameter.

In another preferred aspect of the method of the present disclosure, the syrup comprises about 6% particles of a copolymer of methyl methacrylate and ethylene glycol dimethacrylate.

In yet another preferred aspect of the method of the present disclosure, the article has one or more matte surfaces and one or more non-matte surfaces.

### BRIEF DESCRIPTION OF THE DRAWINGS

FIG. 1 is a perspective view of a matte finish on the surface of an acrylic sheet formed according to a preferred aspect of the present disclosure.

### DETAILED DESCRIPTION OF PREFERRED EMBODIMENT(S) OF THE DISCLOSURE

In the following detailed description, reference is made to the accompanying examples and figures that form a part hereof, and in which is shown, by way of illustration, specific embodiments in which the inventive subject matter may be practiced. These embodiments are described in sufficient detail to enable those skilled in the art to practice them, and it is to be understood that other embodiments may be utilized and that structural or logical changes may be made without departing from the scope of the inventive subject matter. Such embodiments of the inventive subject matter may be referred to, individually and/or collectively, herein by the term “invention” merely for convenience and without intending to voluntarily limit the scope of this application to any single invention or inventive concept if more than one is in fact disclosed.

The following description is, therefore, not to be taken in a limited sense, and the scope of the inventive subject matter is defined by the appended claims and their equivalents.

A preferred embodiment of this disclosure comprises the use of a 15 micron acrylic particle. The particle is highly cross-linked (greater than 2% of formula). It must also have a spherical shape and a narrow particle distribution (D90) between 6 and 25 micron. This particle is incorporated into the acrylic sheet at a loading of 6% by weight in the final formula. Other particles may be used that meet the three criteria listed immediately above and will create a similar texture, but the preferred EXM-12 Matte Particles (described below) give the most aesthetically pleasing appearance. This particular material is used as a light diffusing agent primarily in LCD television displays. Use of EXM-12 Matte Particles allows the finished material to continue to be 100% acrylic in composition.

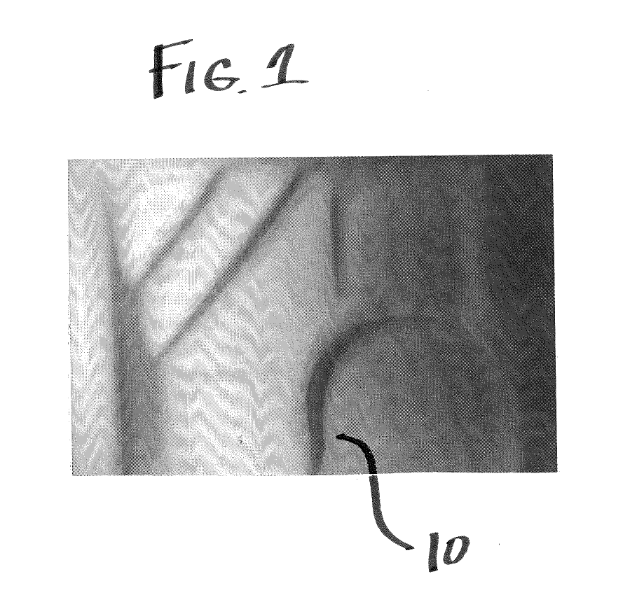

The particle is added to the acrylic syrup as a dry powder and dispersed in a letdown before adding to the full batch. The batch is catalyzed in a similar fashion as existing products that do not use the additive. The material is poured into a two belt continuous casting machine at a rate of 120 inches per minute at 185° F. A second stage oven raises the temperature to 240° F. to finish the curing process. The finished sheets are then thermoformed in a similar fashion as standard acrylic materials used in the bath and hot tub industry. The sheet is heated to 380°-410° and pulled into a mold under vacuum. The resulting finished part will have a matte finish 10 as shown in FIG. 1.

### Formulation for Use in Production of a Matte Finish on Thermoformed Acrylic Sheets

The following composition is preferred formulation of the present disclosure to produce a matte finish upon thermo-forming acrylic composition into thermoformed sheets.

| BASE ACRYLIC FORMULA | % |
|---|---|
| SSI - Acrylic pre-polymerized syrup at 20% solids | 90.4 |
| JX-44 - Triisooctyl phosphate - Anti flocculating agent | 0.57 |
| Pigment | 2.8 |
| JX-1 - n-dodecyl mercaptan - Chain transfer agent | 0.08 |
| Zelec UN - Release agent | 0.01 |
| JX-2 - ethylene glycol dimethacrylate - Crosslinking agent | 0.18 |
| BRB-4 - t-butyl peroxypivalate - Initiator | 0.07 |
| BRB-6 - t-butyl peroxyneodecanoate - Initiator | 0.10 |
| BRB-8 - t-amyl peroxy-2-ethyl-hexanoate - Initiator | 0.02 |
| EXM-12 Matte Particle | 5.8 |

The above preferred baseline formula would account for 100% of the total batch.

EXM-12 is a copolymer of methyl methacrylate and ethylene glycol dimethacrylate, and consists of particles about 10-12 microns in diameter. The addition of these particles does not result in any discernible difference in the cast sheet from a standard sheet cast without the particles. However, when the particle filled sheets are thermoformed, the resultant surface shows a distinct loss in gloss and thus a matte surface appearance.

The EXM-12 particles are highly cross-linked polymethyl methacrylate (PMMA) and preferably are spherical because they are formed through a dispersion polymerization process. Alternative particles such as particles made up of Barium Sulfate, Calcium Carbonate and/or silica that provide some matting may also be used according to preferred embodiments of the present disclosure.

The preferred composition of the present disclosure provides an alternative look and surface upon being thermo-formed. Acrylic sheet used in these applications naturally gives a high gloss final surface once formed. Other approaches to achieving a matte appearance usually involve a sheet with a surface modified in the manufacturing process that becomes increasingly glossy during the thermoforming process. Typical uses for the preferred acrylic composition of the present disclosure include, without limitation, bath tub, sink, and hot tub manufacturers. Other thermo-formed applications are possible as well.

In the foregoing Detailed Description, various features are grouped together in a single embodiment to streamline the disclosure. This method of disclosure is not to be interpreted as reflecting an intention that the claimed embodiments of the disclosure require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A composition for making a cast, thermoformable sheet or slab, comprising: a syrup comprising:
a. about 90% SSI—acrylic pre-polymerized syrup at 20% solids; and
b. about 4-10% particles of a copolymer of methyl methacrylate and ethylene glycol dimethacrylate.

2. The composition of claim 1 wherein the particles are about 10-15 microns in diameter.

3. The composition of claim 1 wherein the particles are about 12 microns in diameter.

4. The composition of claim 1 wherein the particles are about 15 microns in diameter.

5. The composition of claim 1 wherein the particles have a generally spherical shape.

6. The composition of claim 1 wherein the syrup comprises about 6% particles of a copolymer of methyl methacrylate and ethylene glycol dimethacrylate.

7. The composition of claim 1 wherein the syrup further comprises one or more of an anti-flocculating agent; a pigment; a chain transfer agent; a release agent; a crosslinking agent and an initiator.

8. The composition of claim 6 wherein the syrup further comprises:
a. about 3.0% of a pigment;
b. about 0.6% of an anti flocculating agent;
c. about 0.1% of a chain transfer agent;
d. about 0.01% of a release agent;
e. about 0.2% of a crosslinking agent; and
f. about 0.1-0.2% of one or more initiators.

9. A composition for making a cast, thermoformable sheet or slab, comprising: a syrup comprising:
a. about 90% SSI—acrylic pre-polymerized syrup at 20% solids; and
b. about 4-10% particles made up of barium sulfate, calcium carbonate and/or silica.

10. The composition of claim 9 wherein the particles are about 10-15 microns in diameter.

11. A method for producing a thermoformed article having a matte surface comprising:
a. mixing a syrup comprising: about 90% SSI—Acrylic pre-polymerized syrup at 20% solids; and about 4-10% particles of a copolymer of methyl methacrylate and ethylene glycol dimethacrylate;
b. heating the syrup;
c. casting the syrup into a sheet; and
d. thermoforming the cast sheet against a mold.

12. The method of claim 11 wherein the particles are about 10-15 microns in diameter.

13. The method of claim 11 wherein the syrup comprises about 6% particles of a copolymer of methyl methacrylate and ethylene glycol dimethacrylate.

14. The method of claim 11 wherein the article has one or more matte surfaces and one or more non-matte surfaces.
